(19) United States
(12) Patent Application Publication
(10) Pub. No.: US 2017/0003958 A1
(43) Pub. Date: Jan. 5, 2017

(54) NON-TRANSITORY COMPUTER-READABLE RECORDING MEDIUM, INFORMATION PROCESSING DEVICE, AND INFORMATION PROCESSING METHOD

(71) Applicant: FUJITSU LIMITED, Kawasaki-shi (JP)

(72) Inventors: Kimihiro Okubo, Kawasaki (JP); Osamu OYAMADA, Fujisawa (JP); Masahiro Takeda, Kawasaki (JP); Takayuki Hashimoto, Yokohama (JP); KOHSHI YAMAMOTO, Kawasaki (JP); Kohei Uno, Shizuoka (JP); Yasunori Shibata, Kawasaki (JP)

(73) Assignee: FUJITSU LIMITED, Kawasaki-shi (JP)

(21) Appl. No.: 15/195,290

(22) Filed: Jun. 28, 2016

(30) Foreign Application Priority Data
Jul. 2, 2015 (JP) 2015-133886

(51) Int. Cl. G06F 9/44

(52) U.S. Cl. CPC G06F 8/71

(57) ABSTRACT

A non-transitory computer-readable recording medium storing an information processing program causing a computer to execute a process including obtaining a name of a variable usable for a software program and a configuration value of the variable, obtaining a compressed string into which the name of the variable is compressed, writing, to a configuration file, the compressed string and the obtained configuration value so that the compressed string and the obtained configuration value are associated each other, and outputting a configuration value corresponding to an inquiry when the inquiry is received, the inquiry including a designation of a name of a specified variable and a request to obtain a configuration value corresponding to the specified variable, the configuration value corresponding to the specified variable being specified based on a compressed string obtained by compressing the designated name of the specified variable.

### CROSS-REFERENCE TO RELATED APPLICATION

This application is based upon and claims the benefit of priority of the prior Japanese Patent Application No. 2015-133886, filed on Jul. 2, 2015, the entire contents of which are incorporated herein by reference.

### FIELD

The embodiments discussed herein are related to a non-transitory computer-readable recording medium, an information processing device, and an information processing method.

### BACKGROUND

In the related art, the content described in a settings file included in a software product is set to environment variables that specify an operating environment of an operating system (OS) or the like. In the software product, the addition of a feature or a change in the behavior occurs due to an upgrade or to a modification that has been made to fix a failure, and therefore, it is desirable that appropriate environment variables are set for each version.

As a technology related to management of a software product by using a settings file, a computer system has been proposed that enables an installation in accordance with settings specific to each of a plurality of computers when automatic installation is performed on the plurality of computers coupled to the computer system. In such a computer system, an installation server device that receives an installation request from each installation device obtains, from a dedicated information database, installation parameters corresponding to the installation device. In addition, the installation server device creates a settings file that stores a configuration of software to be installed in accordance with the obtained parameters and transmits the settings file to the installation device to perform the installation (see, for example, Japanese Laid-open Patent Publication No. 9-218777).

### SUMMARY

According to an aspect of the embodiment, a non-transitory computer-readable recording medium storing an information processing program causing a computer to execute a process including obtaining a name of a variable usable for a software program and a configuration value of the variable, obtaining a compressed string into which the name of the variable is compressed, writing, to a configuration file, the compressed string and the obtained configuration value so that the compressed string and the obtained configuration value are associated each other, and outputting a configuration value corresponding to an inquiry when the inquiry is received, the inquiry including a designation of a name of a specified variable and a request to obtain a configuration value corresponding to the specified variable, the configuration value corresponding to the specified variable being specified based on a compressed string obtained by compressing the designated name of the specified variable.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating hashing of a settings file;

FIG. 2 is a diagram illustrating management by using branches of source code;

FIG. 3 is a diagram illustrating an increase in the number of branches;

FIG. 4 is a diagram illustrating a case in which source code is managed by a single branch;

FIG. 5 is a diagram illustrating an example of a settings file;

FIG. 6 is a diagram illustrating setting of environment variables;

FIG. 7 is a diagram illustrating a conflict with another application over an environment variable name;

FIG. 8 is a diagram illustrating a difficulty in abbreviating simply an environment variable name;

FIG. 9 is a functional block diagram illustrating a schematic configuration of an information processing device according to an embodiment;

FIG. 10 is a diagram illustrating an example of a settings file;

FIG. 11 is a diagram illustrating an example of environment variables;

FIG. 12 is a block diagram illustrating a schematic configuration of a computer that functions as the information processing device according to the embodiment;

FIG. 13 is a diagram illustrating development and building of a software product;

FIG. 14 is a flowchart illustrating an example of settings file creation processing;

FIG. 15 is a diagram illustrating an example of conversion of a hashed string;

FIG. 16 is a diagram illustrating an example of a settings file when there is a plurality of storage destinations of setting information depending on environment variable names;

FIG. 17 is a diagram illustrating hashing of a settings file;

FIG. 18 is a diagram illustrating installation of the software product;

FIG. 19 is a flowchart illustrating an example of feature execution processing;

FIG. 20 is a flowchart illustrating an example of mapping processing;

FIG. 21 is a diagram illustrating a response of a setting value corresponding to an environment variable name;

FIG. 22 is a diagram illustrating a feature of a mapping program at the time of maintenance;

FIG. 23 is a diagram illustrating a maintenance work when there is no mapping program;

FIG. 24 is a diagram illustrating a maintenance work of a software product that remains in the state of shipment;

FIG. 25 is a diagram illustrating a maintenance work of a software product that has been changed since shipment;

FIG. 26 is a diagram illustrating creation of a normal patch;

FIG. 27 is a diagram illustrating application of a normal patch;

FIG. 28 is a diagram illustrating feature execution of a software product to which the normal patch has been applied;

FIG. 29 is a diagram illustrating creation of an individually corresponding patch;

FIG. 30 is a diagram illustrating application of an individually corresponding patch;

FIG. 31 is a diagram illustrating feature execution of a software product for which the individually corresponding patch has been applied; and

FIG. 32 is a diagram illustrating another configuration example of an execution file group and a mapping unit.

### DESCRIPTION OF EMBODIMENTS

The number of characters allowed to be used to denote an environment variable is limited, and therefore there is a case in which the number of characters denoting the environmental variable based on the content described in the settings file exceeds the limitation. In such a case, there is a problem in that a feature operative using the set environment variable does not operate appropriately.

An object of an embodiment is to reduce the number of characters of a variable written as setting information to a settings file.

Before the embodiment is described in detail, the reason why it is desirable that the number of characters of an environment variable denoting setting information described in a settings file is reduced is described below.

In a software product, there is a case in which a feature is added to the software product due to an upgrade. In addition, when a failure occurs in the software product, a modification to fix the failure is applied to the software product. At this time, it is desirable that source code of each version of the software product is managed so that no operational incompatibility occurs between operations of the respective versions even when the modification is applied to the software product.

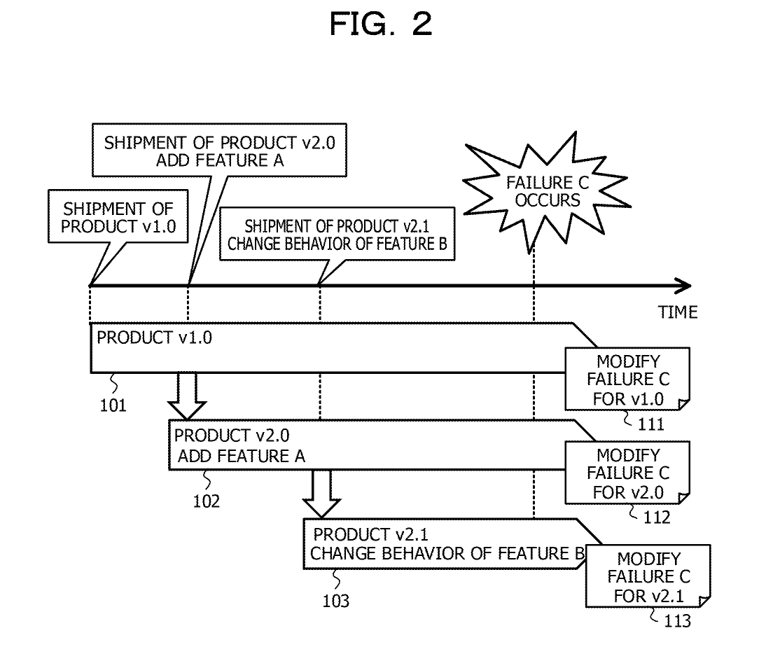

Typically, when a software product is upgraded, a method is used in which the source code of each version is managed separately. In such a management method, as illustrated in FIG. 2, the source code is branched like a tree, and each source code branch is called “a branch”. In the example of FIG. 2, the software product is upgraded to version 2 (hereinafter also referred to as “product v2.0”) by adding feature A to the software product that has been shipped (hereinafter also referred to as “product v1.0”). In addition, the software product is upgraded to version 2.1 (hereinafter also referred to as “product v2.1”) by changing the behavior of feature B. Thus, the management is performed in a state in which a branch 102 of the product v2.0 is branched from a branch 101 of the product v1.0, and a branch 103 of the product v2.1 is branched from the branch 102 of the product v2.0.

Here, it is assumed that a failure C has occurred in the software product in the state in which the above-described branches 101, 102, and 103 are managed. It is desirable that failure modification information used to modify a failure is created by using content corresponding to each of the versions, and the created failure modification information is merely applied to the corresponding version. In the example of FIG. 2, pieces of failure modification information 111, 112, and 113 for the failure C are respectively desired for the branches 101, 102, and 103. As described above, there is a problem that the cost for creating the pieces of failure modification information increases in proportion to the number of branches when the source code for the respective versions is managed by using the branches. The production of pieces of failure modification information, and the associated testing, an inspection, a paperwork, and the like is expensive, and a major problem such as an increase in maintenance man-hours occurs due to an increase in the number of branches.

In order to suppress such an increase in maintenance man-hours, for example, it is conceivable that the number of versions that are support targets is reduced by setting merely the latest version and the previous version as the support targets. However, it is difficult to take such measures in a software product for which guaranteed long-term support is available or a software product with a large number of versions that are support targets.

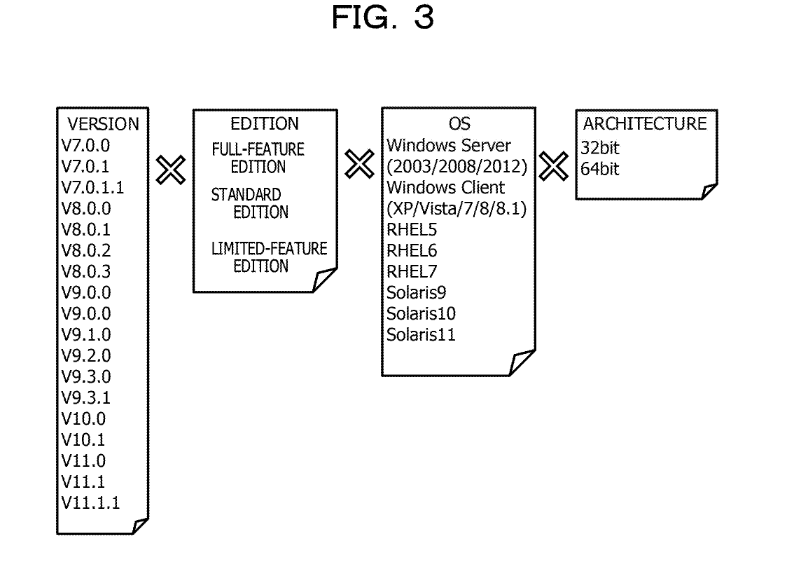

In addition, there is a case in which when different editions such as a limited-feature edition merely including only a certain feature and a full-feature edition including all features included in a software product are provided, the number of branches increases due to such differences between the editions. In addition, there are other factors such as an OS and architecture, each of which increases the number of branches. When such factors are considered, as illustrated in FIG. 3, the number of branches increases exponentially, and therefore the number of branches is greatly increased even when the number of versions to be supported is slightly increased. In addition, there are some cases in which an edition in which merely the behavior of a certain feature is different is provided as an individual version. If a branch is different for each individually provided edition, the number of combinations of the branches increases exponentially.

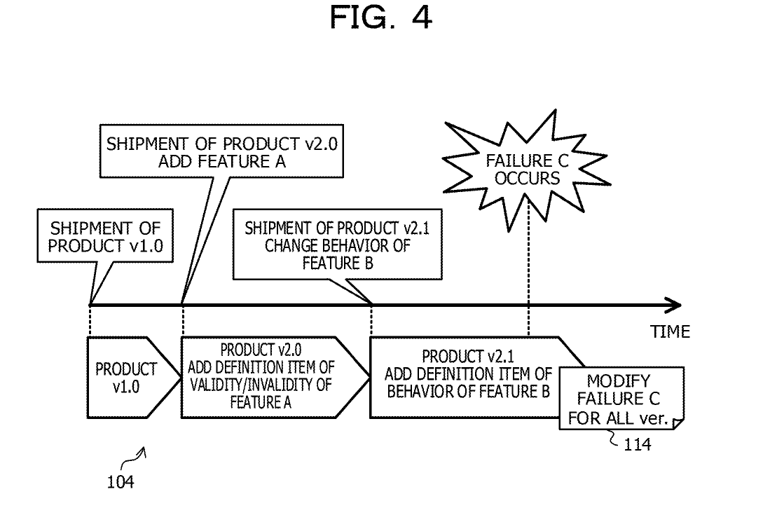

Therefore, in order to reduce the maintenance man-hours in a case in which there are a large number of versions to be supported, for example, it is conceivable that the source code of a particular version is dealt with by a single branch 104 as illustrated in FIG. 4. As a result, pieces of failure modification information 114 are unified, thereby reducing the maintenance man-hours. A description is made below in which “version” is used as a factor to increase the number of branches such as version, edition, OS, or architecture, and the same is true even when other factors are used.

As illustrated in FIG. 4, when version management is performed using the single branch 104, a settings file used to define the operation of each feature included in the software product is prepared, and an appropriate setting value is set for each item defined in the settings file for each version. As a result, the operations for the respective versions may be divided. That is, each time the version is upgraded, a definition item corresponding to an added feature and a definition item corresponding to a change in the behavior of the feature are added to the settings file.

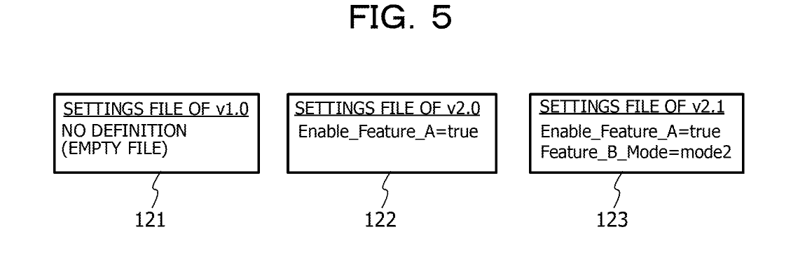

For example, as illustrated in FIG. 5, a definition item does not exist in a settings file 121 of an initial product v1.0, and each feature operates with a default value. In a settings file 122 of a product v2.0 to which feature A has been added, a definition item that determines whether the feature A has been activated to be set (“Enable_Feature_A”) and the corresponding setting value are described. In addition, in a setting file 123 of a product v2.1 in which the behavior of feature B has been changed, a definition item that specifies the behavior of the feature B (“Feature_B_Mode”) is described in addition to the definition item (“Enable_Feature_A”). For example, when “Enable_Feature_A=false” is specified, compatibility between the versions is maintained by enabling the default operation of the old version in which the definition item “Enable_Feature_A” does not exist.

Here, when a plurality of languages such as batch file scripting, shell scripting, C, and Java (registered trademark) may be used to configure a software product, a description format that is easily read and written is language-dependent, and as a result, the description format of the settings file is a problem. For example, in Java in which an application programming interface (API) is available, a property file format is easy to deal with. In a batch file, a batch file format in which an environment variable is set is easy to deal with.

It is conceivable to create a settings file for each feature, but when a plurality of settings files exists, there is also a possibility that omission of data collection increases at the time of incident investigation. In addition, when an identical definition is used for a plurality of features, the identical definition exists in a plurality of settings files. When a setting value of such a definition that exists in the plurality of settings files is rewritten, there is also a possibility that a global inconsistency may occur due to the omission of rewriting in some settings files.

Therefore, the content of the settings file is set to an environment variable of a process for achieving the feature. In another case, for example, after a parent process that calls a feature sets a value described in a format, such as batch file format or a shell script format, to an environment variable of the parent process, a process of the feature is called. As a result, the environment variable of the parent process is passed to the process of the feature, which is a child process. The parent process may not be a direct parent process and may be a parent process of the parent process or a parent process of the parent process of the parent process.

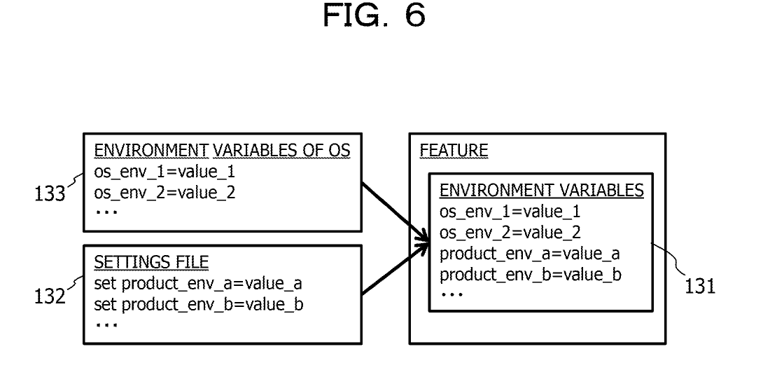

However, as described above, the definitions described in the settings file increase as the version is updated, so that the number of characters set as the environment variable is also increased. The limitation differs depending on an OS, but the number of characters of the entire environment variable is limited, and for example, there is a limitation of 2,047 characters in some versions of Windows (registered trademark). In addition, as illustrated in FIG. 6, in addition to an environment variable described in a settings file 132, an environment variable 133 of an OS or a parent process that calls a feature is also passed to an environment variable 131 used by the feature. Therefore, it is desirable that the number of characters used to denote the environment variable 131 used by the feature is reduced as much as possible.

The environment variable is indicated by a set (or group) of “key-value” in which an environment variable name is described as a “key” and a setting value of an environment variable indicated by the environment variable name is described as a “value”. Therefore, the number of characters set to the environment variable may be reduced by, for example, shortening an environment variable name. As a simple method, it is conceivable that the number of characters of the environment variable name be shortened from the beginning of the environment variable name within a range in which the environment variable name may be distinguished from another environment variable name. For example, when there are an environment variable name “ABC” and an environment variable name “AAA”, the first character is the same “A”, and as a result, the environment variable names are not distinguishable based on the first character alone, but the second character of the environment variable name “ABC” is “B” and the second character of the environment variable name “AAA” is “A”, that is, the second characters are different. Thus, the environment variable name “ABC” may be abbreviated as “AB”, and the environment variable name “AAA” may be abbreviated as “AA”. However, in such a simple reduction in the number of characters, the problem described below occurs.

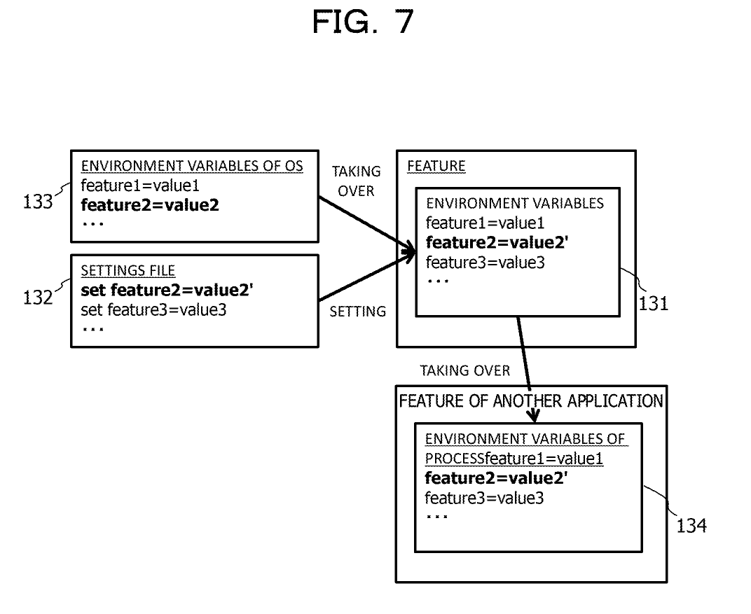

As illustrated in FIG. 7, an identical environment variable name (“feature 2” in the example of FIG. 7) exists in the environment variable that has been taken over from the environment variable 133 of the OS and the environment variable that has been set from the settings file 132, and different setting values are set to have an identical environment value name. In this case, in the environment variable 131 used by the feature, the setting value of “feature 2” that has been taken over from the environment variable 133 of the OS is changed to the setting value that has been set later by the settings file 132. When a certain feature calls another application that runs on the same OS, the environment variable 131 used by the feature that has called the other application is taken over as an environment variable 134 used by a feature of the called application. In the other application that has been called, when the setting value that has been taken over from the environment variable 133 of the OS is desired, there is an influence on the operation of the application because the setting value is written in accordance with the setting value that has been set from the settings file 132. Typically, an environment variable used by the other application that has been called (the other application developed by a third person) corresponds to non-public information, and it is difficult to grasp the information in advance, and as a result, such conflict over environment variable names occurs.

In order to avoid such conflict over environment variable names, a method is conceivable in which a specific prefix is assigned for each software product and feature. For example, a prefix specific to software product such as “FJ_SOFTWARE_***” is assigned to the above-described environment variable “feature2”, and the environment variable name may become “FJ_SOFTWARE_feature2”. In addition, similarly, the environment variable of the OS may become, for example, “OS_feature2” using a prefix, and as a result, conflict over environment variable names may be avoided. However, such assignment of a prefix causes an increase in the total number of characters of an environment variable.

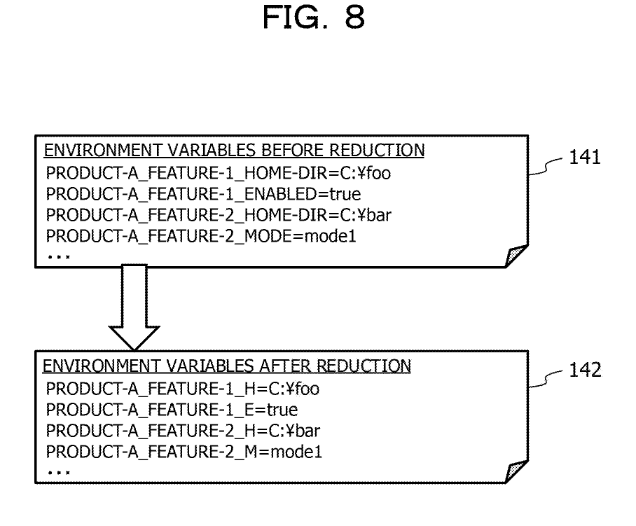

For example, it is assumed that a prefix “PRODUCT-A_FEATURE-1” is assigned to an environment variable name related to feature 1 of a product A. With such a prefix, an environment variable name indicating a path of a home directory of the feature 1 of the product A is “PRODUCT-A_FEATURE-1_HOME-DIR”. Similarly, it is assumed that a prefix “PRODUCT-A_FEATURE-2” is assigned to an environment variable name related to feature 2 of the product A. In this case, as described above, it is conceivable that the number of characters of the environment variable name is reduced by a method in which characters remain within a range in which the environment variable name may be distinguished from other environment variable names. As illustrated in FIG. 8, in environment variables 141 before reduction, a common prefix “PRODUCT-A_FEATURE-1” or “PRODUCT-A_FEATURE-2” is assigned to environment variable names. Therefore, when the characters remain in the range in which the environment variable name may be distinguished from other environment variable names, as illustrated in the reduced environment variables 142 in FIG. 8, the prefix is not allowed to be omitted, and, as a result, a reduction effect of the number of characters of the whole environment variables is low.

Therefore, an object of an embodiment described below is to reduce the number of characters of an environment variable denoting setting information described in a settings file by abbreviating an environment variable name while avoiding conflict over the environment variable names.

An example of the embodiment of the technology is descried below in detail. In the embodiment, as described above, an information processing device is described in which a software product where content of a settings file is set to environment variables of a process used by a feature has been installed.

### Configuration of an Information Processing Device

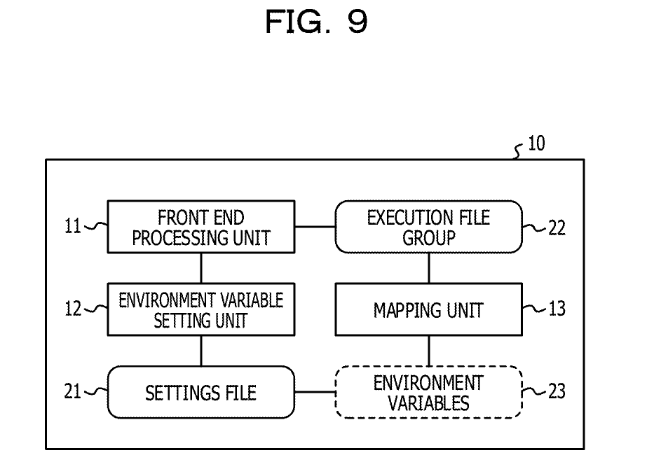

As illustrated in FIG. 9, an information processing device 10 according to the embodiment includes a front end processing unit 11, an environment variable setting unit 12, a mapping unit 13, a settings file 21, and an execution file group 22. The mapping unit 13 is an example of a provision unit according to the embodiment.

The front end processing unit 11 starts an execution file of an instructed feature in response to the instruction received from a user or another application.

The execution file group 22 includes execution files used to respectively operate corresponding features included in a software product. A setting value of an environment variable desired for the execution file that has been started by the front end processing unit 11 is obtained from environment variables 23 that have been set based on the settings file 21. The execution file of each of the features takes over an environment variable name of an environment variable the setting value of which is to be known, to the mapping unit 13. In addition, the execution file operates the specified feature using the setting value that has been obtained by the response from the mapping unit 13.

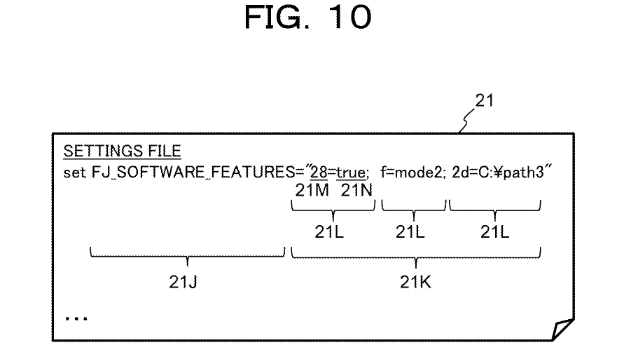

Each pieces of definition set as the environment variables 23 is described in the settings file 21. For example, as illustrated in FIG. 10, in the settings file 21, pieces of setting information 21L of the environment variables are stored in a value 21K of a key-value format using, as a key 21J, a specific string such as a product name of the software product or a feature name of a feature included in the software product. The setting information 21L of each of the environment variables is a set of “key-value” using, as a key 21M, a string in which each of the environment variable names has been converted into a hash value, and that has been abbreviated so that the number of characters is reduced in a range in which the environment variable name may be distinguished from another environment variable name, and in which the setting value of the environment variable is set as a value 21N. The pieces of setting information 21L of the environment variables are divided by delimiters (for example, semicolons), and stored in the value 21K.

A creation method of the settings file 21 is described later in detail.

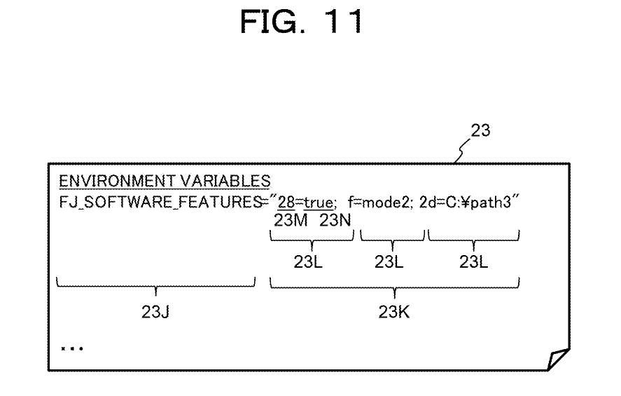

As illustrated in FIG. 11, the environment variable setting unit 12 sets the content described in the settings file 21 as environment variables 23. Similar to the settings file 21, the environment variables 23 have a format in which pieces of setting information 23L of the environment variables each of which is indicated by a set of a key 23M and a value 23N is stored in a value 23K of a key-value format using a specific string as a key 23J.

The mapping unit 13 searches the environment variables 23 for a setting value corresponding to the environment variable name that has been taken over from the execution file of each of the features, and sends back the setting value to the execution file.

For example, the mapping unit 13 identifies the key 23J that matches a string that corresponds to the transferred environment variable name and that has been defined in advance, from the set environment variables 23, and reads the setting information 23L of each of the environment variables stored in the value 23K corresponding to the key 23J. In addition, the mapping unit 13 interprets each of the read pieces of setting information 23L as a set of “key 23M-value 23N”. In addition, the mapping unit 13 calculates a hash value from the environment variable name that has been taken over from the execution file. In addition, the mapping unit 13 searches the sets of “key 23M-value 23N” for the value 23N corresponding to the key 23M that most matches the calculated hash value, and sends back the found value to the execution file.

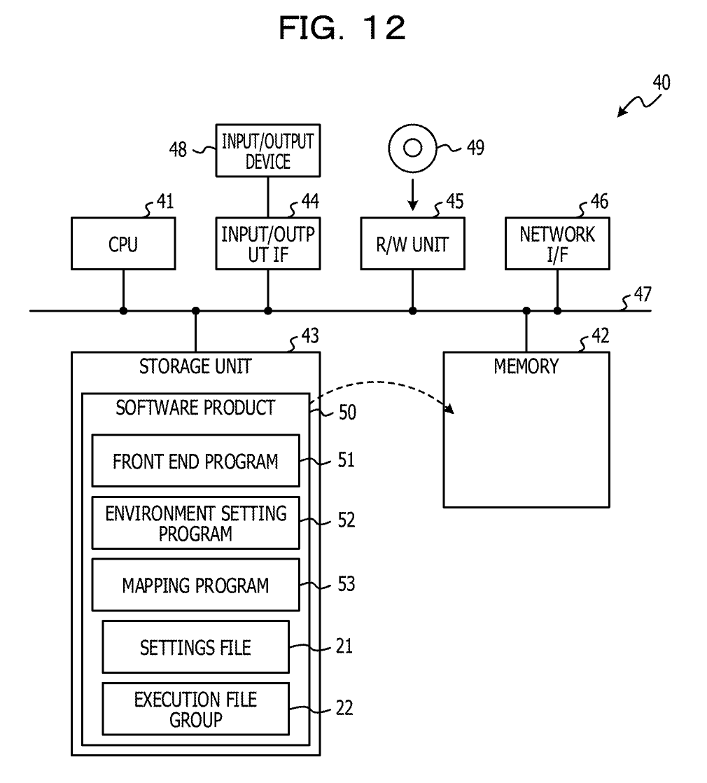

The information processing device 10 may be achieved, for example, by a computer 40 illustrated in FIG. 12. The computer 40 includes a central processing unit (CPU) 41, a memory 42 as a temporary storage area, and a non-volatile storage unit 43. In addition, the computer 40 includes an input/output interface (I/F) 44 to which an input/output device 48 such as a display device and an input device is coupled. In addition, the computer 40 includes a read/write (R/W) unit 45 that controls reading and writing of data for a recording medium 49 and a network I/F 46 coupled to a network such as the Internet. The CPU 41, the memory 42, the storage unit 43, the input/output I/F 44, the R/W unit 45, and the network I/F 46 are coupled to each other through a bus 47.

The storage unit 43 may be achieved by a hard disk drive (HDD), a solid state drive (SSD), a flash memory, or the like. A software product 50 that causes the computer 40 to function as the information processing device 10 is stored in the storage unit 43 as a storage medium. The software product 50 includes a front end program 51, an environment variable setting program 52, a mapping program 53, the settings file 21, and the execution file group 22.

The CPU 41 reads the front end program 51, the environment variable setting program 52, and the mapping program 53 from the storage unit 43, and deploys the programs to the memory 42, and executes processes included in the programs 51, 52, and 53 sequentially.

The CPU 41 operates as the front end processing unit 11 illustrated in FIG. 9 by executing the front end program 51. In addition, the CPU 41 operates as the environment variable setting unit 12 illustrated in FIG. 9 by executing the environment variable setting program 52. In addition, the CPU 41 operates as the mapping unit 13 illustrated in FIG. 9 by executing the mapping program 53. As a result, the computer 40 to which the software product 50 has been installed functions as the information processing device 10.

### Operation of the Information Processing Device

An operation of the information processing device 10 according to the embodiment is described below.

1. Development

First, development of the software product 50 installed to the information processing device 10 is described.

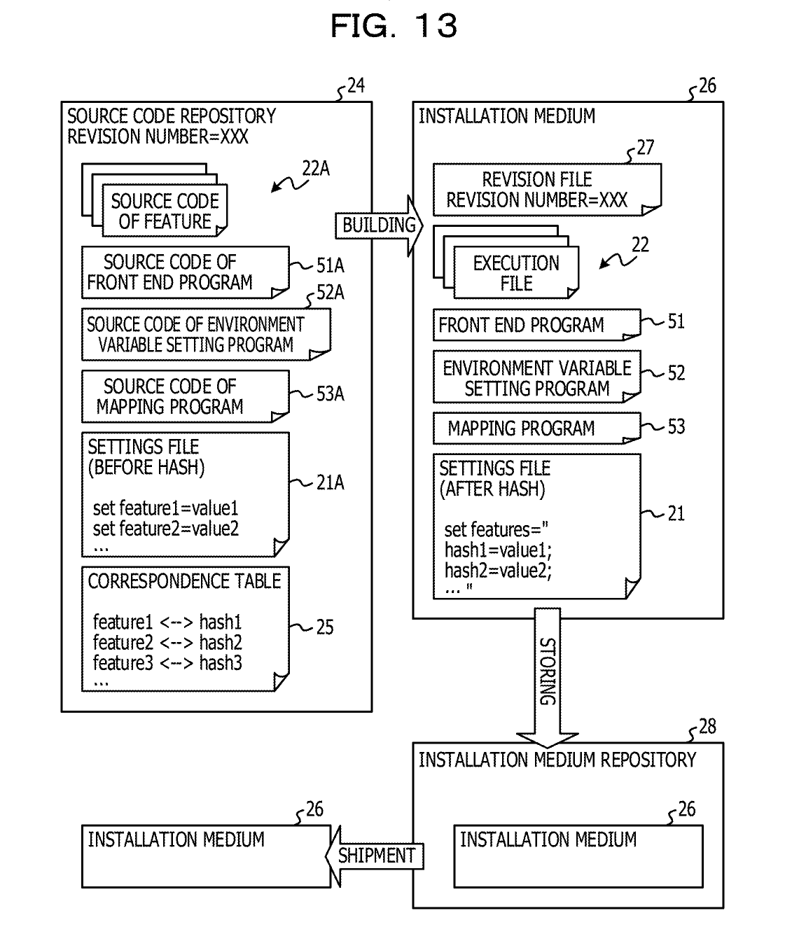

A developer (designer) of the software product 50 creates each file included in the software product 50. In addition, as illustrated in FIG. 13, the created file group is stored in a source code repository 24 that is a certain storage area. The file group includes a source code group 22A for features, a source code 51A of the front end program, source code 52A of the environment variable setting program, source code 53A of the mapping program, a settings file 21A before hash, and a correspondence table 25 between an environment variable name and a reduced hash value. A revision number updated each time storing, update, or deletion is performed on the source code repository 24 is assigned to the file group and managed.

2. Building

Building of the software product 50 is described below.

As illustrated in FIG. 13, the file group stored in the source code repository 24 is built so as to create an installation medium 26. The building of the file group may be performed manually or performed by using a build tool. Here, a case is described in which the building is performed by a build tool.

FIG. 13 illustrates a case in which a Windows (registered trademark) program is created. In the description of FIG. 13, a settings file has a batch file format. When a different OS program is created, the settings file is set to an appropriate format that corresponds to the OS. For example, in a UNIX (registered trademark) program, a shell script or the like is applied to the settings file.

For example, the build tool creates a revision file 27 to which the revision number of the source code repository 24 storing the file group has been transcribed. In addition, the build tool compiles the source code group 22A of the features and the source code 51A, 52A, or 53A of the programs so as to create an execution file group 22 and programs 51, 52, and 53 respectively. In addition, the build tool creates a hashed settings file 21 from the settings file 21A before hash.

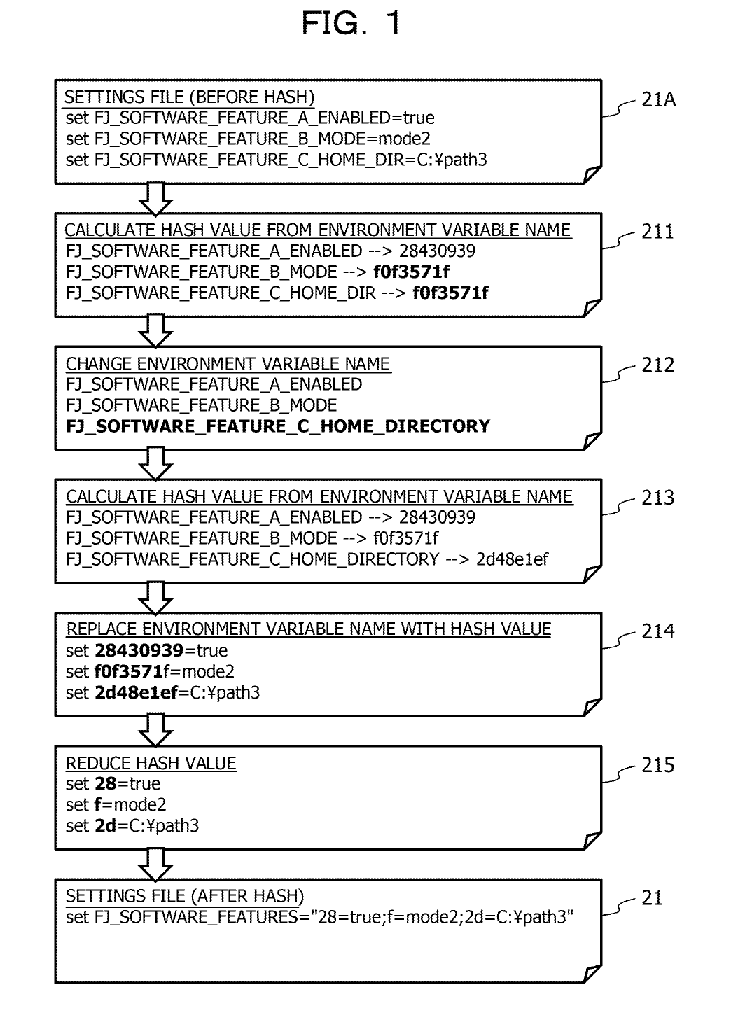

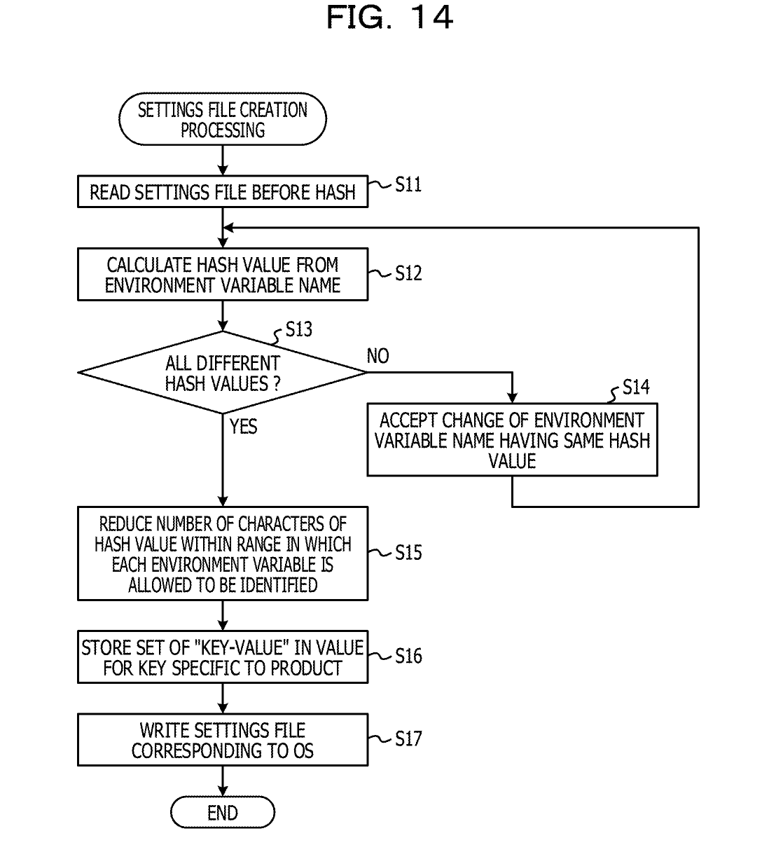

Here, creation of the settings file 21 is described with reference to FIGS. 14 and 1. For example, in a state in which the environment variable names of all environment variables desired for the software product 50 are described in the settings file 21A before hash, the build tool executes settings file creation processing illustrated in FIG. 14.

In Step S11, the build tool reads the settings file 21A before hash from the source code repository 24.

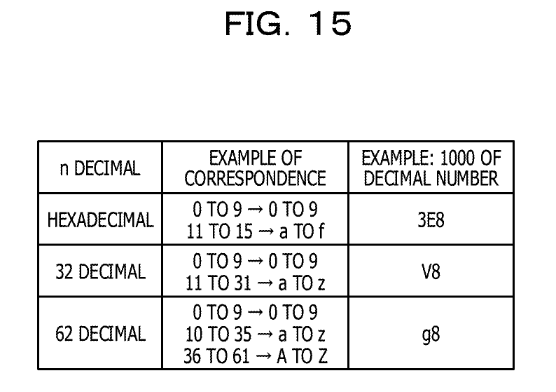

Next, in Step S12, as illustrated in 211 of FIG. 1, the build tool calculates a hash value from each of the environment variable names that have been described in the settings file 21A. For example, the build tool converts the environment variable name into a hash function, and obtains a numeric value in a range from 0 to the maximum value M (“M” depends on the hash function). When a decimal number is used, the number of digits increases, and therefore, in order to improve an effect of a reduction in the number of characters of the environment variables, for example, as illustrated in FIG. 15, the numeric value is represented by a n decimal number, and converted into a string including a number, an alphabet, and a symbol.

Next, in Step S13, the build tool determines whether all of the hash values that have been calculated in the above-described processing of Step S12 are different. At the stage of development of the software product 50, it is possible to define that all of the environment variable names are defined to be different, but there is a case in which hash values that have been calculated from different environment variable names become identical due to the nature of hash values. When a hash function is used in which 0 to the maximum value M appear in the same probability in a case in which an input value is changed randomly, a match probability when hash values are 8-digit hexadecimal numbers is 1/(16̂8)=1/4,294,967,296. In addition, a match probability when hash values are 4-digit 32 decimal numbers is 1/(32̂4)=1,048,576, which is a low probability.

When the hash values are identical, conflict over environment variable names occurs, that is, the determination in this step is determination to guarantee that all calculated hash values are different. When some hash values are identical from among the calculated hash values, the processing proceeds to Step S14, and when all of the calculated hash values are different, the processing proceeds to Step S15. In the example of 211 of FIG. 1, the hash value that has been calculated from the environment variable name of the second line and the hash value that has been calculated from the environment variable name of the third line are identical, and therefore the processing proceeds to Step S14.

In Step S14, the build tool notifies a developer or the like of environment variable names having an identical hash value, and prompts the developer or the like to freely change one of the environment variable names. Before shipment of the software product 50, the developer or the like may change an environment variable name. For example, as illustrated in 212 of FIG. 1, one of the environment variable names having an identical hash value may be changed. The build tool accepts the changed environment variable name, and the processing returns to Step S12.

For the changed environment variable name, a hash value is calculated again, and for example, as illustrated in 213 of FIG. 1, when all of the hash values are different, the processing proceeds to Step S15.

In Step S15, as illustrated in 214 of FIG. 1, the build tool replaces the environment variable names of the settings file 21A with the corresponding hash values. In addition, as illustrated in 215 of FIG. 1, the build tool reduces each of the hash values so that the minimum number of characters remains when viewed from the beginning of the hash value so as to be allowed to be distinguished from another hash value. In the above-described processing of Step S13, it is guaranteed in advance that all of the hash values are different, and therefore the hash values are identified even when the hash values are reduced as described above.

Next, in Step S16, the build tool creates, as the setting information 21L of each of the environment variables, a set of “key-value” by using the reduced hash value as the key 21M, and using a setting value of the environment variable as the value 21N. In addition, the build tool divides the pieces of setting information 21L of the environment variables by delimiters (for example, semicolons) and stores the pieces of information in the value 21K having a key-value format using a specific string of a product name, a feature name, or the like of the software product as the key 21J (see FIG. 10). The delimiter is not limited to a semicolon, and another symbol may be used. As described above, in a case in which the specific string is set as the key 21J, even when an environment variable name used for a feature of the software product 50 and an environment variable name used for a feature of another application are identical as illustrated in FIG. 7, conflict over reference destinations may be avoided.

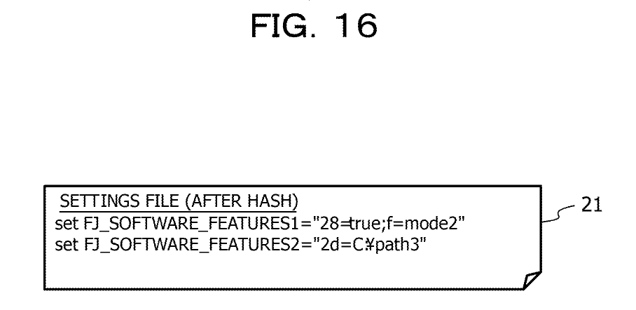

In the example of FIG. 1, the case is described in which the single key 21J is defined to the settings file 21, but a plurality of keys 21J may be defined for each of features, groups into which features have been grouped, or the like. For example, for the settings file 21A before hash illustrated in FIG. 1, environment variables related to feature A (FEATURE_A) and feature B (FEATURE_B) are set as a single group, and a single key 21J is assigned to the group. In addition, another key 21J may be assigned to an environment variable related to feature C (FEATURE_C). In this case, for example, as illustrated in FIG. 16, the value 21K corresponding to each of the keys 21J stores the setting information 21L of the corresponding environment variable.

Such grouping of features may be set so that a developer, a person who is responsible for maintenance, or the like manages the groups easily. For example, the setting information 21L of a path-related environment variable may be stored in the value 21K corresponding to the key 21J “paths”. In addition, for example, when the software product 50 is divided correspondingly to each component, and the environment variables 23 are referred to for each of the components, the setting information 21L of an environment variable used by a component A may be stored in the value 21K corresponding to the key 21J “component A”.

Next, in Step S17, the build tool writes the settings file 21 using a language corresponding to the OS in which the software product 50 operates (for example, a batch file or a shell script), and the settings file creation processing ends.

It is assumed that the above-described settings file creation processing is executed after all environment variables desired for the software product 50 have been determined, and this is why it is guaranteed that all reduced hash values becomes different.

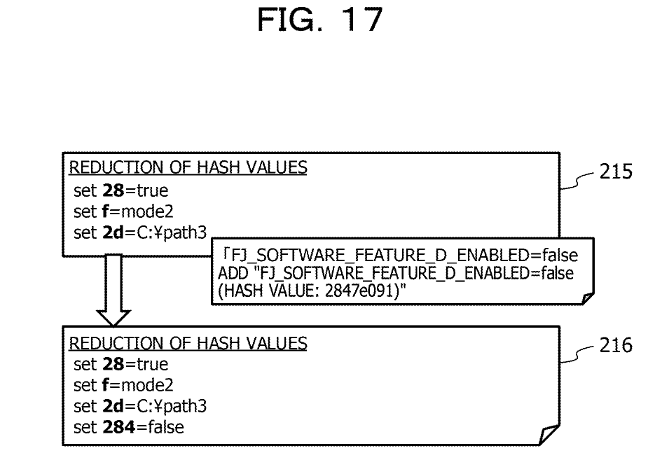

For example, as illustrated in 215 of FIG. 17, it is assumed that reduced hash values are obtained for environment variable names that have been determined at that stage before all of environment variable names are determined. At that stage, pieces of information on the hash values before reduction (see 214 of FIG. 1) have been lost. Under such a situation, for example, it is assumed that addition of definition of “FJ_SOFTWARE_FEATURE_D_ENABLED=false” (environment variable name+setting value) is performed. When it is assumed that a hash value “2847e091” is calculated from the environment variable name “FJ_SOFTWARE_FEATURE_D_ENABLED”, the hash value is reduced into “284” (216 of FIG. 17) allowed to be distinguished from the reduced hash value (215 of FIG. 17) that has been already obtained. In this case, as a setting value of an environment variable in which a hash value calculated from an environment variable name starts from “284”, it is difficult to determine whether the first line or the fourth line in 216 of FIG. 17 is to be referred to. In order to avoid such a situation, after all of the environment variable names have been determined, the hashed settings file 21 is created from the settings file 21A before hash.

The revision file 27, the execution file group 22 and the programs 51, 52, and 53, and the hashed settings file 21 that have been created as described above are stored in an installation medium repository 28 as the installation medium 26, as illustrated in FIG. 13. At the time of shipment of the software product 50, the installation medium 26 is taken out from the installation medium repository 28 and shipped.

A correspondence table 25 between an environment variable name stored in the source code repository 24 and a corresponding reduced hash value is not included in the installation medium 26. In the correspondence table 25, the reduced hash value and the environment variable name are associated with each other one-to-one, and may be created manually or using an automatic creation tool. For example, the correspondence table 25 may be created by associating the environment variable name described in the settings file 21A before hash, which has been read in Step S11 of the above-described settings file creation processing with the hash value that has been reduced in Step S15.

When the settings file 21A stored in the source code repository 24 is updated, and a new environment variable name is added to the settings file 21A, the correspondence table 25 is also updated. To the correspondence table, the respective correspondence relationships between environment variable names that have been used for all revisions including an environment variable name that is not described in the settings file 21A of the current revision and the corresponding reduced hash values are recorded.

3. Installation

Installation of the software product 50 is described below.

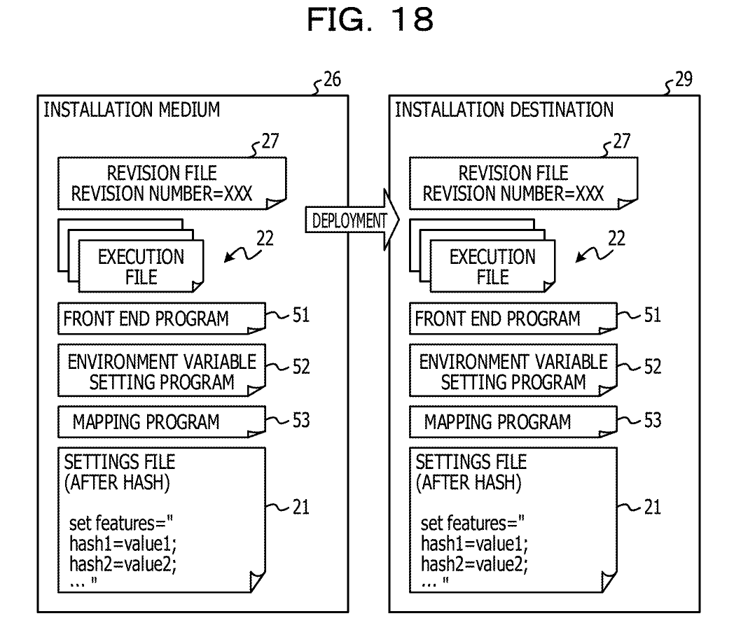

At the time of installation, as illustrated in FIG. 18, the execution file group 22 and the programs 51, 52, and 53, the settings file 21, and the revision file 27 included in the installation medium 26 are deployed to a certain installation destination 29. In the embodiment, the installation destination 29 corresponds to the storage unit 43 of the computer 40 (see FIG. 12).

4. Feature Execution

Execution of a feature included in the software product 50 is described below.

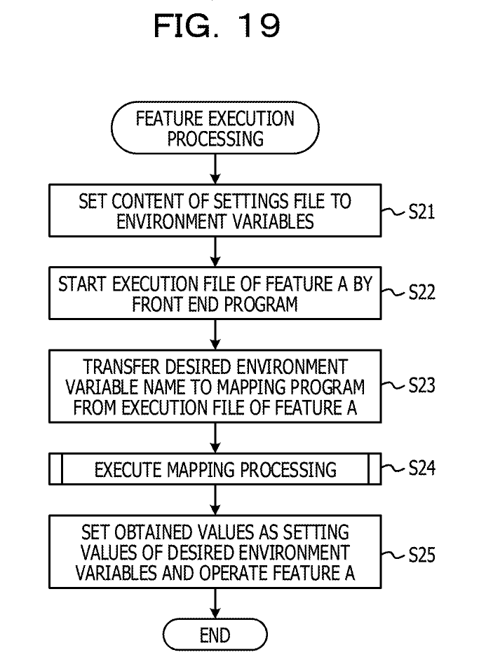

When any feature included in the software product 50 is specified by the user in the computer 40 that is the installation destination 29 of the software product 50 (installation medium 26), the feature execution processing illustrated in FIG. 19 is executed in the computer 40. Here, it is assumed that feature A is specified by the user.

In Step S21, the front end program 51 executes the environment variable setting program 52. That is, the front end processing unit 11 causes the environment variable setting unit 12 to function, and causes the content of the settings file 21 to be set to the environment variables 23.

Next, in Step S22, the front end processing unit 11 starts an execution file of the feature A. Next, in Step S23, the execution file of the feature A transfers an environment variable name of an environment variable desired for an operation of the feature A to the mapping unit 13 in order to obtain a setting value of the environment variable. Here, it is assumed that an environment variable name “FJ_SOFTWARE_FEATURE_A_ENABLED” is transferred to the mapping unit 13.

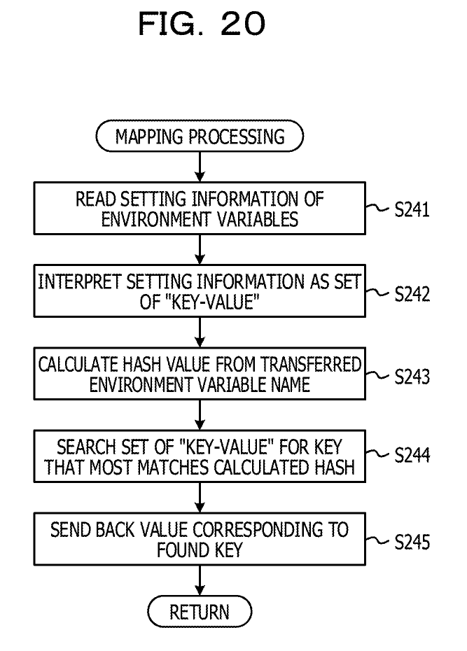

Next, in Step S24, the mapping program 53 is started, and the mapping processing illustrated in FIG. 20 in detail is executed.

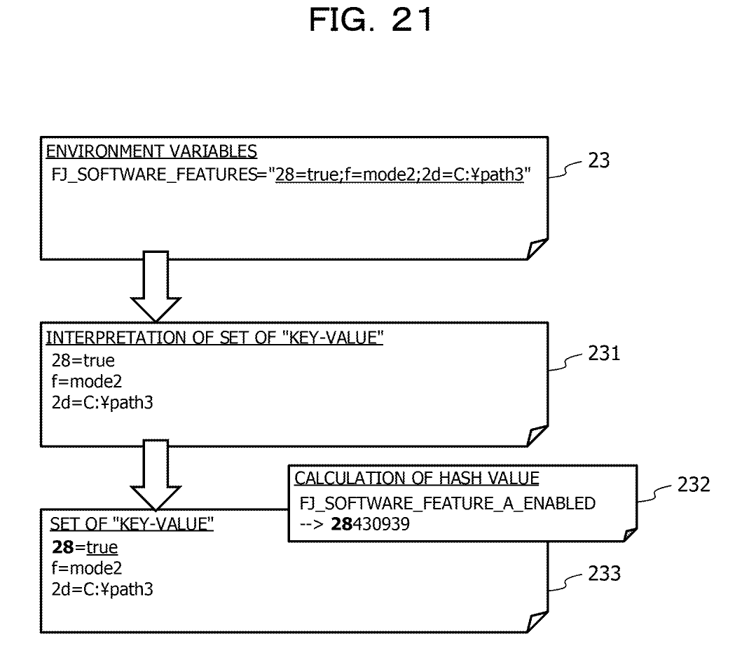

In Step S241 of the mapping processing illustrated in FIG. 20, the mapping unit 13 reads the value 23K corresponding to the key 23J that has been defined in advance in accordance with the transferred environment variable, from the environment variable 23 that has been defined with a format of “key 23J-value 23K” (see FIG. 11). For example, it is assumed that the key 23J “FJ_SOFTWARE_FEATURES” is defined for the environment variable name “FJ_SOFTWARE_FEATURE_A_ENABLED”. In this case, as illustrated in FIG. 21, reading of the value 23K corresponding to the key 23J “FJ_SOFTWARE_FEATURES” (underlined part in the environment variables 23 of FIG. 21) is performed. It is assumed that a correspondence relationship between the environment variable name and the key 233 has been set to the mapping program 53 in advance.

Next, in Step S242, the mapping unit 13 extracts a single piece of setting information 23L from the read value 21K, for each delimiter, and interprets each of the pieces of setting information 23L as a set of “key-value” (“key”=“value”), as illustrated in 231 of FIG. 21.

Next, in Step S243, as illustrated in 232 of FIG. 21, the mapping unit 13 calculates a hash value from the environment variable name that has been transferred from the execution file. Here, it is assumed that a hash value “28430939” has been calculated from the environment variable name “FJ_SOFTWARE_FEATURE_A_ENABLED”.

Next, in Step S244, the mapping unit 13 searches the sets of “key-value” that have been interpreted in the above-described Step S242 for a key that most matches the hash value that has been calculated in the above-described Step S243. Here, the first key of the sets of “key-value” illustrated in 233 of FIG. 21 most matches the hash value “28430939” that has been calculated in the above-described Step S243.

Next, in Step S245, the mapping unit 13 obtains a value corresponding to the key that has been found in the above-described Step S244 (here, “true”, that is, the underlined part in 233 of FIG. 21), and sends back the value to the execution file of the feature A, and the flow returns to the feature execution processing.

Next, in Step S25 of the feature execution processing illustrated in FIG. 19, the execution file of the feature A sets the value that has been obtained by the response from the mapping unit 13 as the setting value of the environment variable. That is, definition of “FJ_SOFTWARE_FEATURE_A_ENABLED=true” is set, and the feature A operates, and the feature execution processing ends. As a result, the operation of the feature A is divided in accordance with the definition that has been set to the settings file 21.

When there is a plurality of environment variables, the above-described processing of Steps S23 and S24 is repeated. In addition, it is only sufficient that the above-described processing of Step S21 is executed before the mapping unit 13 refers to the environment variables 23, and therefore, for example, the processing of Step S21 may be executed after Step S23.

5. Maintenance (Incident Correspondence)

Next, the maintenance of the software product 50 is described below.

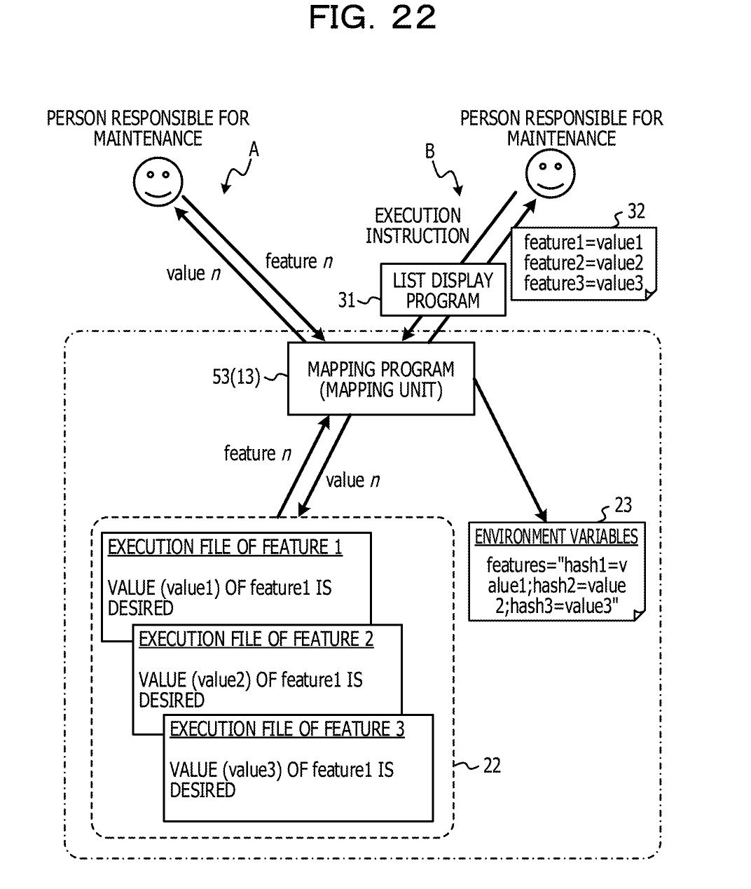

As described above, an execution file of each of the features transfers an environment variable name (feature_n) to the mapping program 53. The mapping program 53 sends back the corresponding setting value to the execution file (value_n) with reference to the set environment variables 23 (dashed line in FIG. 22).

Even at the time of maintenance, using the feature of the mapping program 53, a setting value of an environment variable that is an investigation target may be obtained. For example, as illustrated in A of FIG. 22, when the person who is responsible for maintenance transfers the environment variable name (feature_n) of the investigation target to the mapping program 53, a corresponding setting value (value_n) may be obtained.

In addition, as illustrated in B of FIG. 22, setting values of a plurality of environment variables may be obtained as a list 32 using a list display program 31. For example, the person who is responsible for maintenance instructs the list display program 31 to perform the execution. The list display program 31 enquires about all environment variables desired for the execution file group 22 in order for the mapping program 53. In addition, when the list display program 31 obtains all setting values from the mapping program 53, the list display program 31 lists environment variable names and corresponding setting values, and displays the list on a display device (not illustrated). The list display is not limited to a case in which a list for all environment variables is displayed, and specification of environment variables to be included in the list may be accepted.

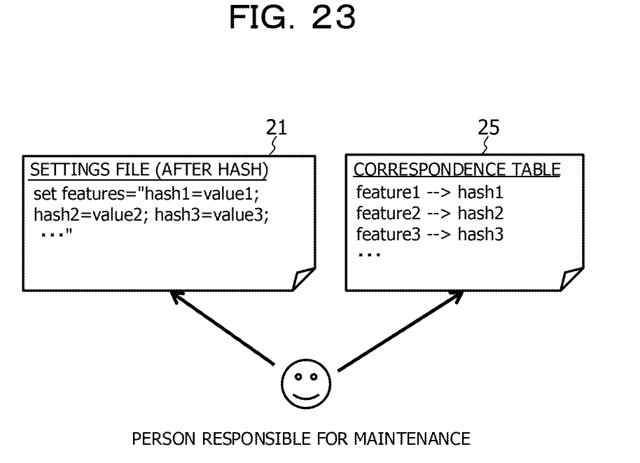

Here, a case is conceivable in which an environment variable name defined to a settings file is merely hashed, and the mapping program 53 according to the embodiment is not provided. In this case, as illustrated in FIG. 23, it is desirable that the person who is responsible for maintenance compares the hashed settings file 21 of the software product 50 that is an investigation target with the correspondence table 25 between an environment variable and a corresponding reduced hash value, and reads a setting value of the environment variable of the investigation target. In this case, an appropriate maintenance work may not be performed due to a reading error caused by a shift of a line to be checked in the correspondence table 25.

In the embodiment, when the mapping program 53 is provided, it is only sufficient for the user side (execution file or the person who is responsible for maintenance) to specify an environment variable name, and therefore a mistake hardly occurs.

In addition, it is unnecessary for the user side to have the correspondence table 25, and therefore there is no load that the correspondence table 25 of the user side is replaced each time a settings file is updated.

A case is described below in which there is no influence on decryption of the settings file 21 at the time of maintenance work (including check of contents other than a setting value of an environment variable that is an investigation target) even when the settings file 21 has been hashed as described above.

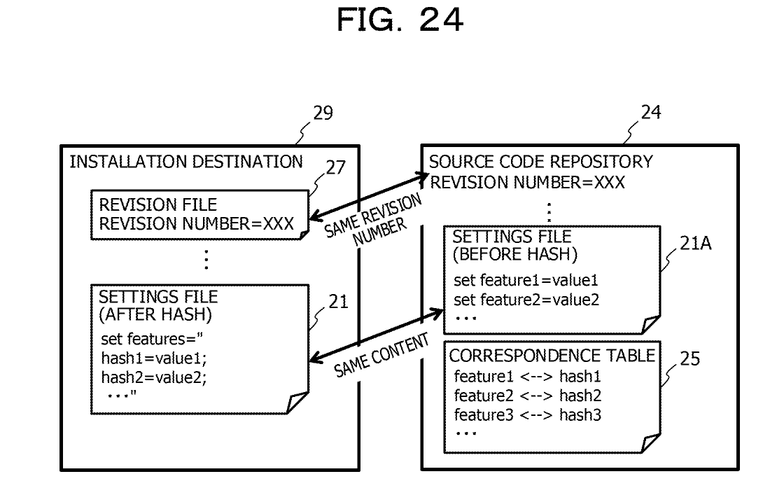

First, a case is described in which the settings file 21 of the software product 50 that has been installed in the installation destination 29 remains in the state of shipment of the software product 50. Whether the settings file remains in the state of the shipment may be checked based on a revision number described in the revision file 27. As illustrated in FIG. 24, the person who is responsible for maintenance refers to the settings file 21A before hash of a file group managed using the revision number that has been checked in the revision file 27 of the installation destination 29, in the source code repository 24. The content of the settings file 21A before hash and the content of the hashed settings file 21 that has been installed in the installation destination 29 are the same, and therefore the content of the hashed settings file 21 may be checked.

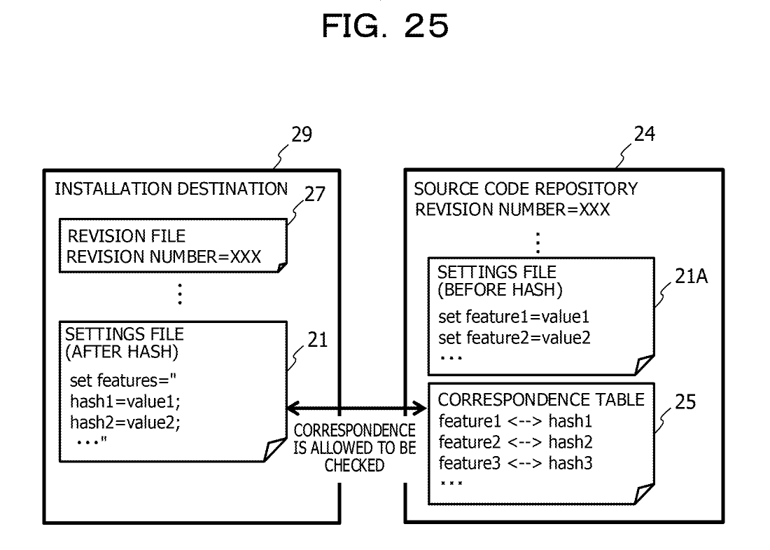

Next, maintenance is described in a case in which an environment abnormality occurs due to unauthorized rewriting by the user, a bug, or the like after the shipment of the software product 50. When an environment abnormality occurs, there is no guarantee that the mapping program operates normally. In this case, as illustrated in FIG. 25, the person who is responsible for maintenance checks the correspondence table 25 to which the latest revision number has been assigned and stored in the source code repository 24. In the correspondence table 25 of the latest revision number, all correspondence relationships between environment variables that have been defined by the previous revisions and corresponding reduced hash values are described. Therefore, the content of the hashed settings file 21 that has been installed in the installation destination 29 may be deciphered with reference to the correspondence table 25.

6. Application of a Patch

Next, a case is described in which a normal patch is applied to the software product 50 the shipment of which has been completed. The normal patch is a patch other than an individually corresponding patch described later.

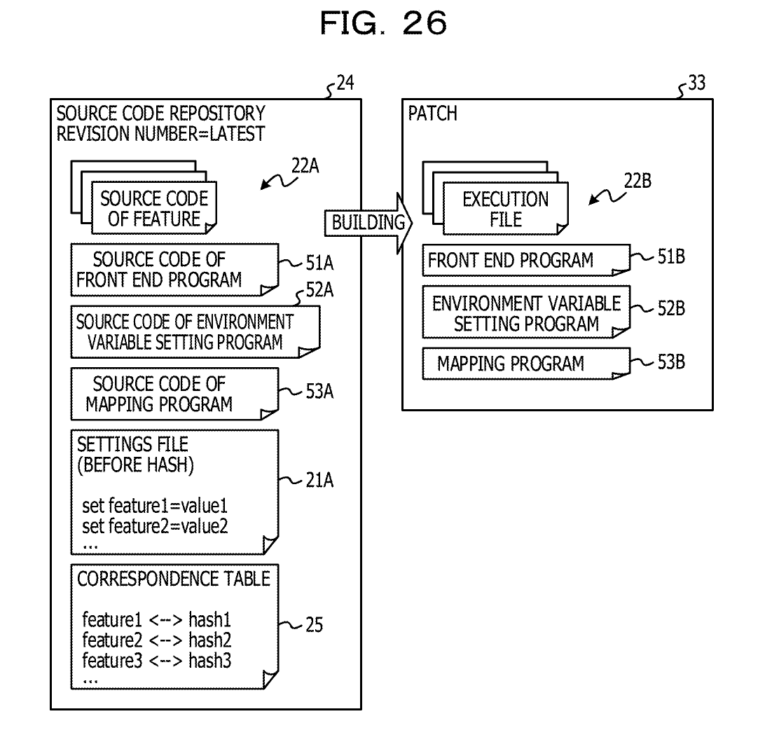

As illustrated in FIG. 26, a normal patch 33 is created by building each source code stored in the source code repository 24 and to which the latest revision number has been added. That is, the normal patch 33 includes the latest execution file group 22B and the programs 51B, 52B, and 53B. The pieces of data (the settings file 21A and the correspondence table 25) other than the source code are not included in the patch.

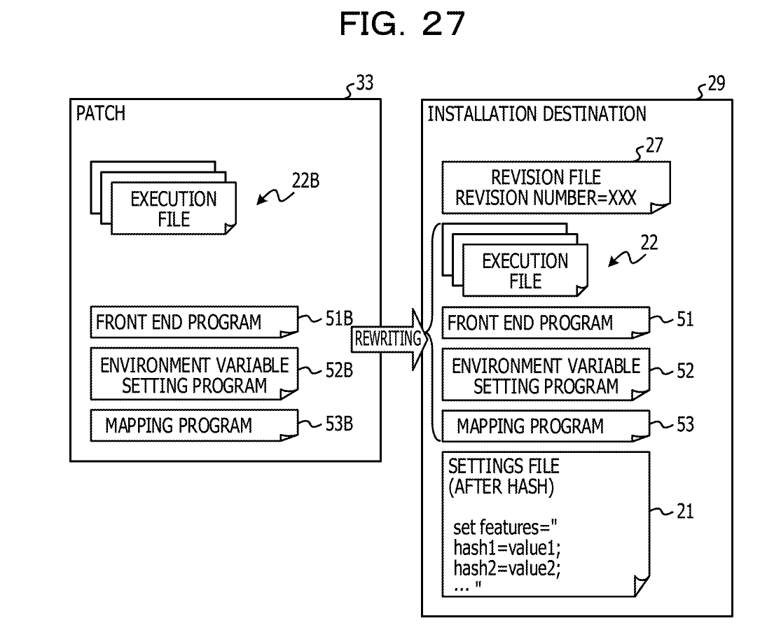

Application of the normal patch 33 to the software product 50 of the installation destination 29 corresponds to rewriting of the programs 51, 52, and 53 and the execution file group 22 of the installation destination 29 in the created normal patch 33 as illustrated in FIG. 27. As a result, merely the execution file group 22 and the programs 51, 52, and 53 are updated.

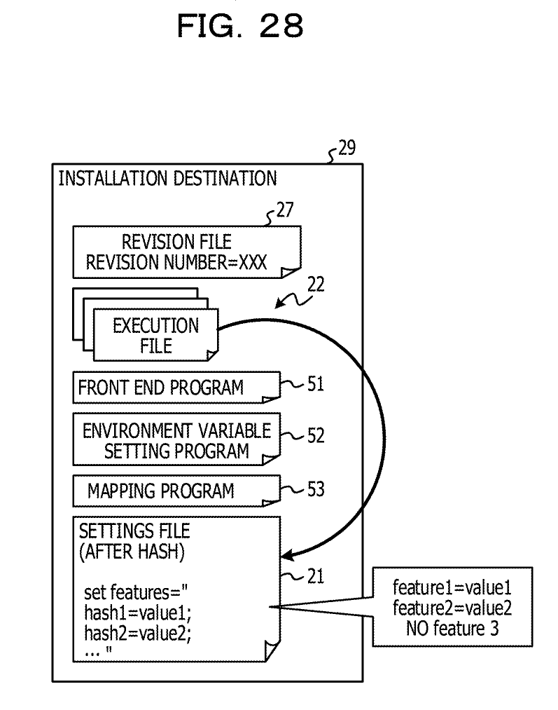

An operation at the time of feature execution after the normal patch has been applied is basically similar to that of the above-described execution feature. However, due to the application of the normal patch 33, when addition of new definition related to a certain feature has been performed, the new definition is not described in the settings file 21 because the settings file 21 is not updated. For example, as illustrated in FIG. 28, when an environment variable “feature3” has been defined as definition of feature 3, it is desirable that an execution file of the feature 3 refers to a setting value of the environment variable “feature3”. However, in the settings file 21, the setting information 21L of the environment variable “feature 3” is not described. In this case, the feature 3 that uses the environment variable “feature3” operates with a default value stored internally, and therefore no problem occurs. Typically, in order to maintain the compatibility before and after application of a patch, the operation before the application of the patch is set as a default value. However, a problem may occur in the operation before the application of the patch in a special case such as a case in which there is a security issue, and therefore there is a case in which the default value is different from the operation before the application of the patch.

Next, a case is described in which an individually corresponding patch is applied to the software product 50 the shipment of which has been completed.

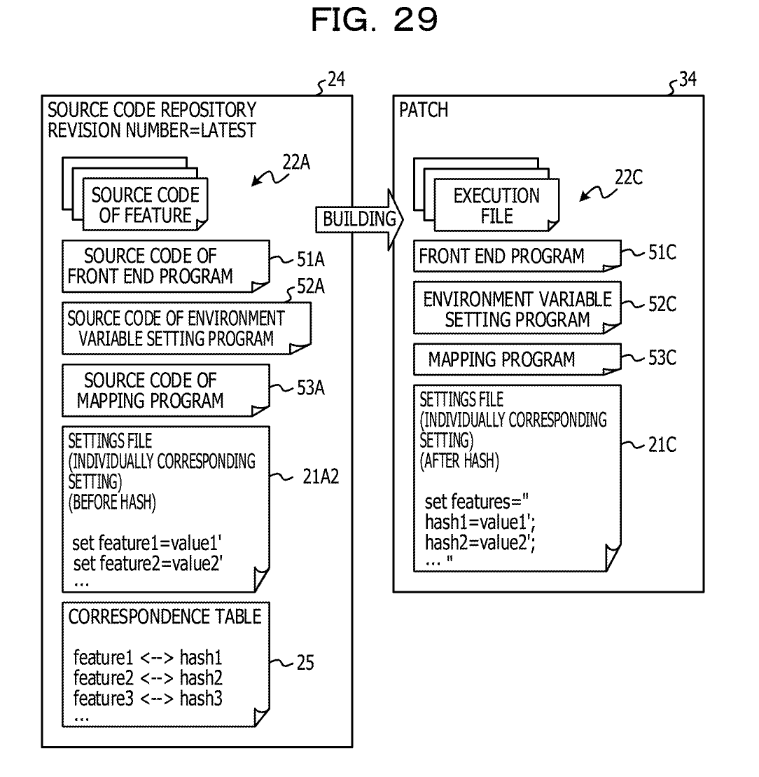

As illustrated in FIG. 29, an individually corresponding patch 34 is created by building a settings file 21A2 and each source code stored in the source code repository 24 and to which the latest revision number has been assigned. In the settings file 21A2, individually corresponding definition is described. That is, the individually corresponding patch 34 includes the latest execution file group 22C and the programs 51C, 52C, and 53C, and individually corresponding hashed settings file 21C. The correspondence table 25 is not included in the patch.

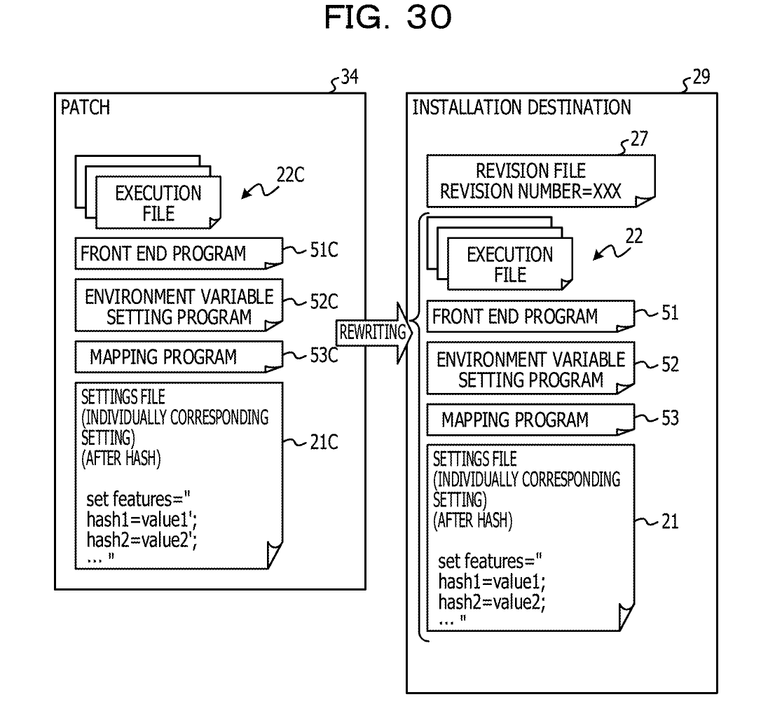

The application of the individually corresponding patch 34 to the software product 50 of the installation destination 29 corresponds to rewriting of the programs 51, 52, and 53 and the execution file group 22 of the installation destination 29 in the created patch 34 as illustrated in FIG. 30. In addition, due to the application of the individually corresponding patch 34, the settings file 21 is also rewritten. As a result, the execution file group 22 and the programs 51, 52, and 53 are updated, and the settings file 21 is individually dealt with.

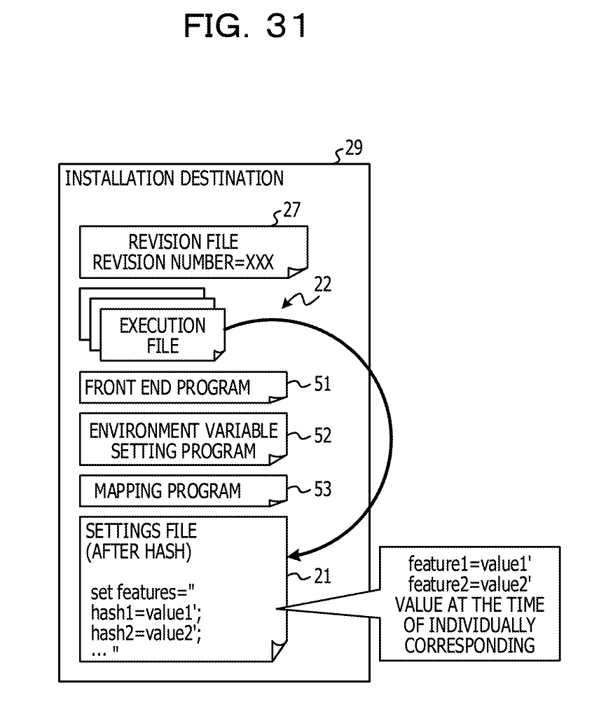

An operation at the time of feature execution after the individually corresponding patch has been applied is basically similar to that of the above-described feature execution. However, due to the application of the individually corresponding patch 34, a setting value of an environment variable that has been defined in the settings file 21 becomes an individually corresponding value. Therefore, as illustrated in FIG. 31, a feature using the environment variable to which the individually corresponding setting value has been set operates in accordance with the individually corresponding definition. In the example of FIG. 31, when setting values of environment variables “feature1” and “feature2” are normally “value1” and “value2”, but become “value1′” and “value2′” as the individually correspondence setting value.

As described above, in the information processing device in which the software product according to the embodiment has been installed, an environment variable name that has been defined in a settings file is hashed and abbreviated, and therefore the number of characters of setting information of a variable written to the settings file may be reduced. In addition, it is only sufficient that the environment variable name is transferred to the mapping program to obtain a corresponding setting value, and therefore mistake of check or the like of the setting value at the time of maintenance or usage of the environment variable by the feature may be avoided.

In addition, the value that has been obtained by hashing and abbreviating the environment variable name is obtained so that all environment variables desired for the software product become different, and therefore conflict over environment variable names may be avoided. In addition, setting information of each of the environment variables is stored in a value of a key-value format using a specific string of a software product, a feature of the software product, or the like as a key. Therefore, conflict over environment variable names with another application may also be avoided.

In the above-described embodiment, the case is described in which the settings file 21A before hash is stored in the source code repository 24, but the embodiment is not limited to the case. For example, the hashed settings file 21 may be created manually or using a tool other than the build tool from the settings file 21A before hash, and stored in the source code repository 24. In this case, at the time of building, the hashed settings file 21 stored in the source code repository 24 may be included in the installation medium 26 as is.

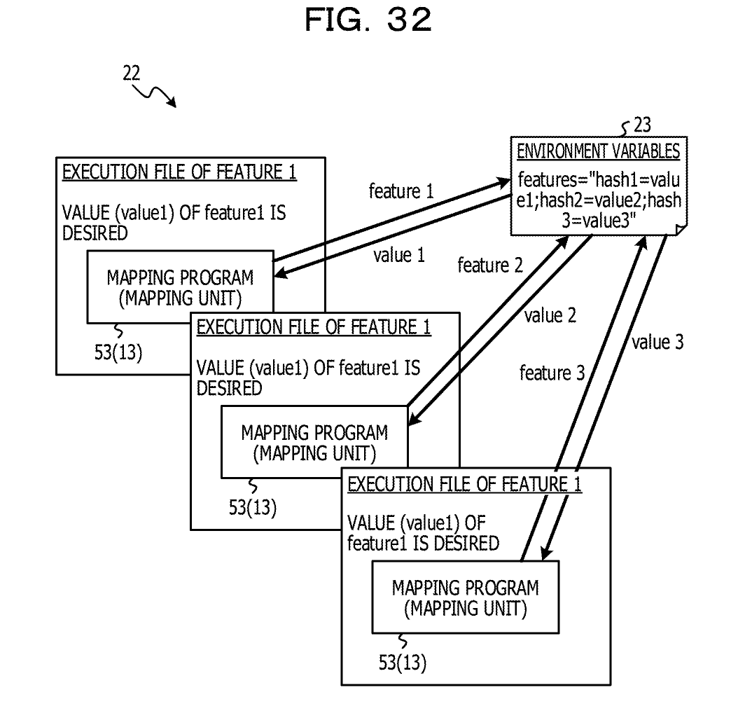

In addition, in the above-described embodiment, the case is described in which the mapping program 53 is provided separately from the execution file group 22, but the embodiment is not limited to the case. For example, as illustrated in FIG. 32, the mapping program 53 may be included in an execution file of each feature. In this case, even when the execution file of each of the features is started, and a setting value of an environment variable is desired, the mapping program 53 included in the execution file of each of the features may obtain a desired setting value with reference to the environment variables 23.

In addition, in the above-described embodiment, the case is described in which a string obtained by hashing and abbreviating an environment variable name is used as a compressed string of the environment variable name, but the embodiment is not limited to the case. It is only sufficient that all environment variable names desired for the software product are allowed to be identified, and the number of characters is smaller than those of the original environment variable name.

The example is described above in which the software product 50 is stored (installed) in the storage unit 43 in advance, but the embodiments are not limited to the example. The software product may be provided so as to be recorded to a recording medium such as a CD-ROM, a DVD-ROM, or a USB memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program causing a computer to execute a process comprising:
obtaining a name of a variable usable for a software program and a configuration value of the variable;
obtaining a compressed string into which the name of the variable is compressed;
writing, to a configuration file, the compressed string and the obtained configuration value so that the compressed string and the obtained configuration value are associated each other; and
outputting a configuration value corresponding to an inquiry when the inquiry is received, the inquiry including a designation of a name of a specified variable and a request to obtain a configuration value corresponding to the specified variable, the configuration value corresponding to the specified variable being specified based on a compressed string obtained by compressing the designated name of the specified variable.

2. The non-transitory computer-readable recording medium according to claim 1, wherein
the compressed string is a hash value calculated from the name of the variable.

3. The non-transitory computer-readable recording medium according to claim 1, wherein
the compressed string is a string whose number of characters is less than a number of characters of the name of the variable, the compressed string whose number of characters is reduced is abbreviated in a range in which the name of the variable is capable of distinguishing from a name of another variable.

4. The non-transitory computer-readable recording medium according to claim 3, wherein the processor configured to:
writing, in the writing, configuration information in a key-value format by using a string with which the software program or each feature of the software program is identifiable and by using an aggregate of sets, each of the sets including a string obtained by abbreviating the compressed string and the configuration value, the used string corresponding to a key of the key-value format, each of the sets corresponding to a value of the key-value format.

5. The non-transitory computer-readable recording medium according to claim 4, wherein
in the aggregate of the sets, the sets are arranged so as to be divided by delimiters and stored as a value in the key-value format.

6. The non-transitory computer-readable recording medium according to claim 1, wherein
a configuration value associated with a specified string is output in response to the inquiry, the specified string having highest correlation with the compressed string obtained by compressing the designated name of the specified variable.

7. The non-transitory computer-readable recording medium according to claim 1, wherein
a list of configuration values respectively corresponding to a plurality of name of variables is output as the response when the plurality of names of variables is designated by the inquiry.

8. An information processing device comprising:
a memory; and
a processor configured to:
obtain a name of a variable usable for a software program and a configuration value of the variable;
obtain a compressed string into which the name of the variable is compressed;
write, to a configuration file, the compressed string and the obtained configuration value so that the compressed string and the obtained configuration value are associated each other; and
output a configuration value corresponding to an inquiry when the inquiry is received, the inquiry including a designation of a name of a specified variable and a request to obtain a configuration value corresponding to the specified variable, the configuration value corresponding to the specified variable being specified based on a compressed string obtained by compressing the designated name of the specified variable.

9. An information processing method comprising:
obtaining a name of a variable usable for a software program and a configuration value of the variable;
obtaining a compressed string into which the name of the variable is compressed;
writing, to a configuration file, the compressed string and the obtained configuration value so that the compressed string and the obtained configuration value are associated each other; and
outputting a configuration value corresponding to an inquiry when the inquiry is received, the inquiry including a designation of a name of a specified variable and a request to obtain a configuration value corresponding to the specified variable, the configuration value corresponding to the specified variable being specified based on a compressed string obtained by compressing the designated name of the specified variable.
